(19) United States
(12) Patent Application Publication
(10) Pub. No.: US 2026/0211360 A1
(43) Pub. Date: Jul. 23, 2026

(54) IMAGE FORMING APPARATUS THAT CONTROLS FIXING TEMPERATURE

(71) Applicant: KYOCERA Document Solutions Inc., Osaka (JP)

(72) Inventors: Takayuki MASHIMO, Osaka (JP); Hiroki TANAKA, Osaka (JP); Kenichi KASAMA, Osaka (JP)

(73) Assignee: KYOCERA Document Solutions Inc., Osaka (JP)

(21) Appl. No.: 19/444,489

(22) Filed: Jan. 9, 2026

(30) Foreign Application Priority Data
Jan. 17, 2025 (JP) 2025-007171

(51) Int. Cl. G03G 15/20; G03G 15/00

(52) U.S. Cl. CPC G03G 15/2039; G03G 15/2064; G03G 15/50; G03G 2215/2074; G03G 2215/208

(57) ABSTRACT

A controller acquires a first value which is a total of the pixel value of each of pixels, included in each of N×M pieces of blocks, defines A×B pieces of object blocks in the N×M pieces of blocks, by grouping a predetermined number of the blocks into one object block, calculates a second value which is a total of the first value of the predetermined number of the blocks, included in each of the A×B pieces of object blocks, calculates an average of a total of the second value of each of the A pieces of object blocks, aligned in a sheet transport direction at a position of a b-th object block in an orthogonal direction to the sheet transport direction, and a total of the second value of each of the A pieces of object blocks, aligned at a position of a (b+1)th object block.

### INCORPORATION BY REFERENCE

This application claims priority to Japanese Patent Application No. 2025-007171 filed on Jan. 17, 2025, the entire contents of which are incorporated by reference herein.

### BACKGROUND

The present disclosure relates to an image forming apparatus, and in particular to a technique to control a fixing temperature.

Existing electrophotographic image forming apparatuses include an image forming device that forms a toner image on a sheet on the basis of image data, and a fixing device that heats and presses the sheet on which the toner image has been formed. Such an image forming apparatus is required to suppress power consumption, while maintaining a fixing temperature that enables the toner image to be surely fixed onto the sheet. Since an amount of deposited toner on the sheet is highly correlated with a pixel value of the image data, a technique has been developed including calculating the deposited toner amount on the basis of the pixel value, to thereby determine the fixing temperature, as a control method of the fixing temperature.

According to the known technique to control the fixing temperature, on the basis of the deposited toner amount, first the image is divided into meshes, and count information indicating the deposited toner amount of a plurality of pixels in a mesh (total of the deposited toner amounts of the plurality of pixels) with respect to each of the meshes, and position information of the corresponding mesh are acquired, and stored in a memory. Then a block of N×M pieces of meshes is defined as a region, and positions where the deposited toner amount is high are searched all over the image, by shifting the search position by increments of one mesh, and the fixing temperature is determined on the basis of the search result.

### SUMMARY

The disclosure proposes further improvement of the foregoing technique.

In an aspect, the disclosure provides an image forming apparatus including an image forming device, a fixing device, a transport device, and a control device. The image forming device forms a toner image on a sheet, on a basis of image data. The fixing device heats and presses the sheet on which the toner image has been formed. The transport device transports the sheet to the image forming device and the fixing device. The control device includes a processor, and acts as a controller that controls a fixing temperature of the fixing device, when the processor executes a control program. The controller executes a total pixel value acquisition process, including acquiring a first total pixel value which is a total of the pixel value of each of a plurality of pixels, included in each of N×M pieces of blocks, defined by dividing the image data into a predetermined size. The controller defines A×B pieces of object blocks in the N×M pieces of blocks, by grouping a predetermined number of the blocks, according to data resolution of the image data, into one object block, and executes a total pixel value calculation process including calculating a second total pixel value, which is a total of the first total pixel value of the predetermined number of the blocks, included in each of the A×B pieces of object blocks. The controller arranges the A×B pieces of object blocks such that A pieces of blocks are aligned along a transport direction of the sheet by the transport device, and B pieces of blocks are aligned along an orthogonal direction orthogonal to the transport direction, and executes an average value calculation process, including calculating a b-th average value (b being an integer between 1 and B−1, both ends inclusive), which is an average of a total of the second total pixel value of each of the A pieces of object blocks, aligned in the transport direction at a position of a b-th object block in the orthogonal direction, and a total of the second total pixel value of each of the A pieces of object blocks, aligned in the transport direction at a position of a (b+1)th object block in the orthogonal direction. The controller executes a fixing temperature setting process, including setting the fixing temperature of the fixing device to a predetermined first fixing temperature, when at least one of the b-th average values exceeds a predetermined threshold, and setting the fixing temperature of the fixing device to a fixing temperature, predetermined according to the b-th average value, and lower than the first fixing temperature, when none of the b-th average values exceed the predetermined threshold.

In another aspect, the disclosure provides an image forming apparatus including an image forming device, a fixing device, a transport device, and a control device. The image forming device forms a toner image on a sheet using a plurality of colors, on a basis of image data. The fixing device heats and presses the sheet on which the toner image has been formed. The transport device transports the sheet to the image forming device and the fixing device. The control device includes a processor, and acts as a controller that controls a fixing temperature of the fixing device, when the processor executes a control program. The controller executes a total pixel value acquisition process, including acquiring, with respect to each of the colors, a first total pixel value of a color, which is a total of the pixel value of the color, of each of a plurality of pixels included in each of N×M pieces of blocks, defined by dividing the image data into a predetermined size. The controller defines A×B pieces of object blocks in the N×M pieces of blocks, by grouping a predetermined number of the blocks, according to data resolution of the image data, into one object block, and executes a total pixel value calculation process including calculating, with respect to each of the colors, a second total pixel value of a color, which is a total of the first total pixel value of the color, of the predetermined number of the blocks, included in each of the A×B pieces of object blocks. The controller arranges the A×B pieces of object blocks such that A pieces of blocks are aligned along a transport direction of the sheet by the transport device, and B pieces of blocks are aligned along an orthogonal direction orthogonal to the transport direction, and executes an average value calculation process, including calculating a b-th average value (b being an integer between 1 and B−1, both ends inclusive), which is an average of a total of the second total pixel value of each of the plurality of colors, of each of the A pieces of object blocks, aligned in the transport direction at a position of a b-th object block in the orthogonal direction, and a total of the second total pixel value of each of the plurality of colors, of each of the A pieces of object blocks, aligned in the transport direction at a position of a (b+1)th object block in the orthogonal direction. The controller executes a fixing temperature setting process, including setting the fixing temperature of the fixing device to a predetermined first fixing temperature, when at least one of the b-th average values exceeds a predetermined threshold, and setting the fixing temperature of the fixing device to a fixing temperature, predetermined according to the b-th average value, and lower than the first fixing temperature, when none of the b-th average values exceed the predetermined threshold.

### BRIEF DESCRIPTION OF THE DRAWINGS

FIG. 1 is a front cross-sectional view showing an outline of an image forming apparatus according to an embodiment of the disclosure;

FIG. 2 is a block diagram showing an internal configuration of the image forming apparatus shown in FIG. 1;

FIG. 3 is a block diagram showing a functional configuration of the system controller and the engine controller shown in FIG. 2;

FIG. 4A is a schematic drawing for explaining a control process of a fixing temperature of the fixing device shown in FIG. 2;

FIG. 4B is a schematic drawing for explaining the control process of the fixing temperature of the fixing device shown in FIG. 2;

FIG. 5A is a schematic drawing for explaining the control process of the fixing temperature of the fixing device shown in FIG. 2;

FIG. 5B is a schematic drawing for explaining the control process of the fixing temperature of the fixing device shown in FIG. 2;

FIG. 5C is a schematic drawing for explaining the control process of the fixing temperature of the fixing device shown in FIG. 2;

FIG. 5D is a schematic drawing for explaining the control process of the fixing temperature of the fixing device shown in FIG. 2;

FIG. 6A is a schematic drawing for explaining the control process of the fixing temperature of the fixing device shown in FIG. 2;

FIG. 6B is a schematic drawing for explaining the control process of the fixing temperature of the fixing device shown in FIG. 2;

FIG. 7A is a schematic drawing for explaining the control process of the fixing temperature of the fixing device shown in FIG. 2;

FIG. 7B is a schematic drawing for explaining the control process of the fixing temperature of the fixing device shown in FIG. 2;

FIG. 8 is a flowchart showing a setting process of the fixing temperature of the fixing device, performed by a fixing controller shown in FIG. 3;

FIG. 9 is another flowchart showing a setting process of the fixing temperature of the fixing device, performed by the fixing controller shown in FIG. 3; and

FIG. 10 is a schematic diagram showing a flow of the image forming operation, performed by the image forming apparatus shown in FIG. 1.

### DETAILED DESCRIPTION

Hereafter, an image forming apparatus according to an embodiment, representing an aspect of the disclosure, will be described with reference to the drawings.

### Configuration of Image Forming Apparatus 1

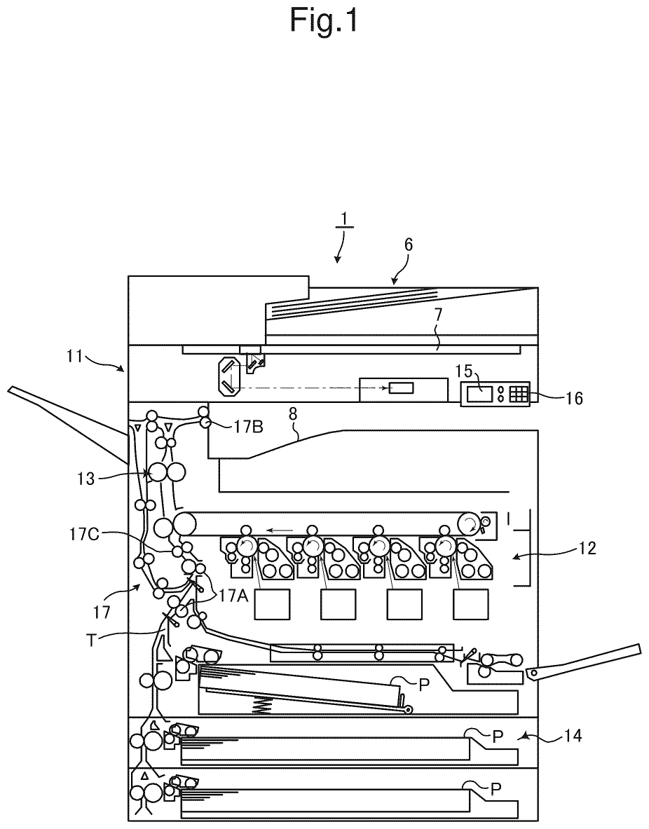

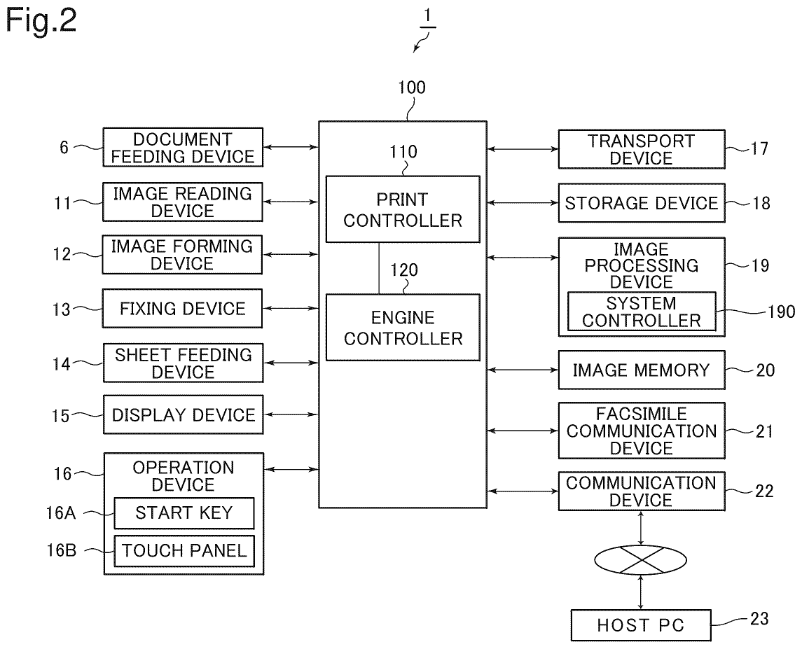

FIG. 1 is a front cross-sectional view showing an outline of the image forming apparatus 1 according to the embodiment of the disclosure. FIG. 2 is a block diagram showing an internal configuration of the image forming apparatus 1 shown in FIG. 1. The image forming apparatus 1 is a multifunction peripheral having a plurality of functions, such as copying, transmitting, printing, and facsimile transmission.

The image forming apparatus 1 includes, as shown in FIG. 1, a document feeding device 6, an image reading device 11, an image forming device 12, a fixing device 13, a sheet feeding device 14, a display device 15, an operation device 16, and a transport device 17.

The document feeding device 6 delivers documents placed on a document tray one by one to a reading position of the image reading device 11. The document feeding device 6 is configured to open and close a platen glass 7, by being made to pivot up and downward about a shaft located on the deeper side in FIG. 1. The document feeding device 6 also serves as a document retention cover that presses the document on the platen glass 7 from the upper side.

The image reading device 11 includes a scanner that optically reads the document, and generates image data representing the document image. The image reading device 11 reads the document delivered from the document feeding device 6, or the document placed on the platen glass 7.

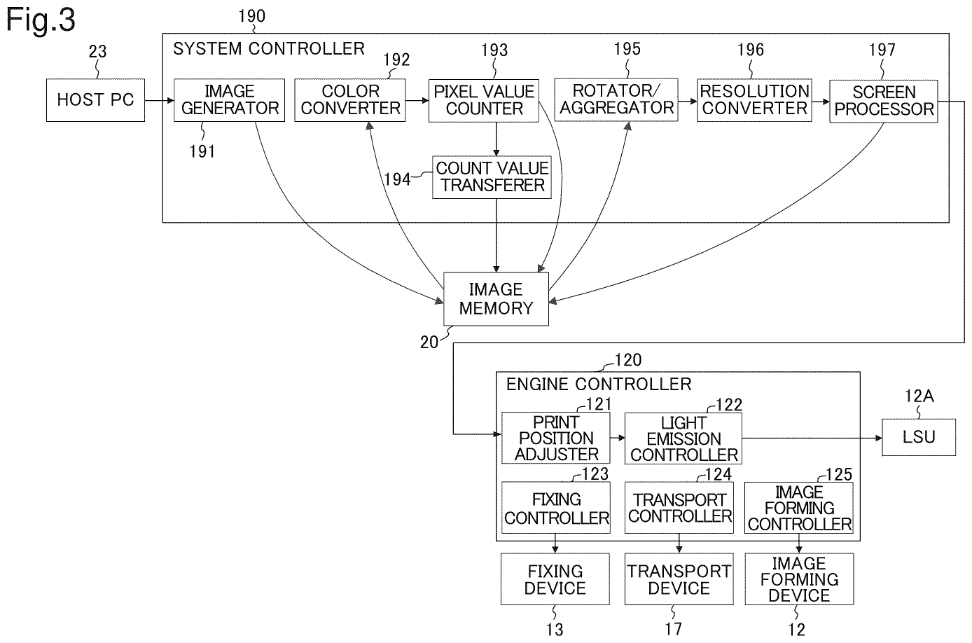

The image forming device 12 includes a photoconductor drum, a charging device, an exposure device, a developing device, and a transfer device. The exposure device includes a laser scanning unit (LSU) 12A (see FIG. 3). The image forming device 12 forms a toner image on a sheet P transported along a transport route T by the transport device 17, on the basis of the image data. In the case of color printing, an image forming unit for magenta, an image forming unit for cyan, an image forming unit for yellow, and an image forming unit for black, included in the image forming device 12, form the toner image of the respective colors, on a photoconductor drum through charging, exposing, and developing processes. The toner images of the respective colors formed as above are transferred and overlaid on each other on an intermediate transfer belt via a primary transfer roller, thus to be formed into a colored toner image. Such colored toner image is transferred via a secondary transfer roller to the sheet P, transported along the transport route T. In the case of monochrome printing, the image forming unit for black in the image forming device 12 forms a black toner image on the photoconductor drum, through the charging, exposing, and developing processes. The black toner images formed as above is transferred to the intermediate transfer belt via the primary transfer roller. The monochrome toner image transferred to intermediate transfer belt is transferred, via the secondary transfer roller, to the sheet P transported along the transport route T.

The fixing device 13, including a heater such as a heat roller, and a presser such as a pressure roller, heats and presses the sheet P on which the toner image has been formed, to thereby fix the toner image onto the sheet P. The sheet P on which the toner image has been fixed is delivered to an output tray 8.

The sheet feeding device 14 includes a manual bypass tray and a plurality of sheet cassettes. The sheet feeding device 14 draws out the sheets P stored in one of the plurality of sheet cassettes, or set on the manual bypass tray one by one with a pickup roller, and delivers the sheet P to the transport route T. Here, the sheet P is not limited to a paper medium but may be, for example, an overhead projector (OHP) sheet.

The display device 15 includes a liquid crystal display or an organic light-emitting diode display. The display device 15 displays various types of screen.

The operation device 16 includes, as shown in FIG. 2, a plurality of hard keys such as a start key 16A, for inputting instructions to execute a copying operation or a scanning operation. The operation device 16 also includes a touch panel 16B overlaid on the display device 15. To the operation device 16, the instruction from the user is inputted.

The transport device 17 includes transport roller pairs 17A, a delivery roller pair 17B, a resist roller 17C, and a transport motor. When the transport roller pair 17A, the delivery roller pair 17B, and the resist roller 17C are driven to rotate by the transport motor, the sheet P delivered from the sheet feeding device 14 is transported along the transport route T, to the image forming device 12 and the fixing device 13.

The image forming apparatus 1 further includes, as shown in FIG. 2, a control device 100, a storage device 18, an image processing device 19, an image memory 20, a facsimile communication device 21, and a communication device 22.

The control device 100 is electrically connected to the document feeding device 6, the image reading device 11, the image forming device 12, the fixing device 13, the sheet feeding device 14, the display device 15, the operation device 16, the transport device 17, the storage device 18, the image processing device 19, the image memory 20, the facsimile communication device 21, and the communication device 22.

The control device 100 controls the operation of each component of the image forming apparatus 1. The control device 100 includes a print controller 110 and an engine controller 120. The print controller 110 and the engine controller 120 are configured to communicate with other through a bus, via a communication interface.

The storage device 18 is a large-capacity storage medium, such as a hard disk drive (HDD) or a solid state drive (SSD), for storing various types of data, and containing various computer programs including control programs for realizing the functions of the image forming apparatus 1. As an example of the control programs, a fixing temperature control program, for controlling the fixing temperature of the fixing device 13, is installed in the storage device 18.

The image processing device 19 is a circuit that executes image processing with respect to the image data. The image processing device 19 includes a system controller 190. In the image memory 20, the image data is temporarily stored. The facsimile communication device 21 transmits and receives the image data, through the public telephone network.

The communication device 22 includes a communication module such as a local area network (LAN) board. The control device 100 performs data communication via the communication device 22, with an external device such as a host personal computer (PC) 23 connected via a network.

A power source is connected to each of the components of the image forming apparatus 1. When the user turns the power on, the power is supplied from the power source, to each of the components of the image forming apparatus 1.

### Control of Fixing Temperature

In this embodiment, the image data is divided into N×M pieces of blocks, each having a predetermined size, such that N pieces of blocks are aligned in a predetermined first direction, and M pieces of blocks are aligned in a second direction orthogonal to the first direction. In the case of normal printing operation, the first direction and the second direction respectively correspond to the transport direction of the sheet P by the transport device 17, and the orthogonal direction orthogonal to the transport direction. Hereinafter, the transport direction of the sheet P by the transport device 17, and the orthogonal direction orthogonal to the transport direction will be respectively referred to as “sub scanning direction” and “main scanning direction”, where appropriate.

The amount of heat removed from the heater of the fixing device 13 is determined depending on the toner amount, deposited along the sub scanning direction over an entire page, at a position along the main scanning direction. Conventionally, the heater of the fixing device 13 is heated to such a temperature that prevents defective fixing result, even when a maximum toner amount is deposited on the sheet. However, in the case where it is possible to recognize the deposited toner amount along the sub scanning direction over the entire page, at the position along the main scanning direction, before the sheet P reaches the heater of the fixing device 13, the temperature of the heater of the fixing device 13 can be controlled according to the deposited toner amount along the sub scanning direction over the entire page, at the position along the main scanning direction. In the case of successive printing operation, the heater is reheated during the interval between the sheets P, as preparation for the next printing.

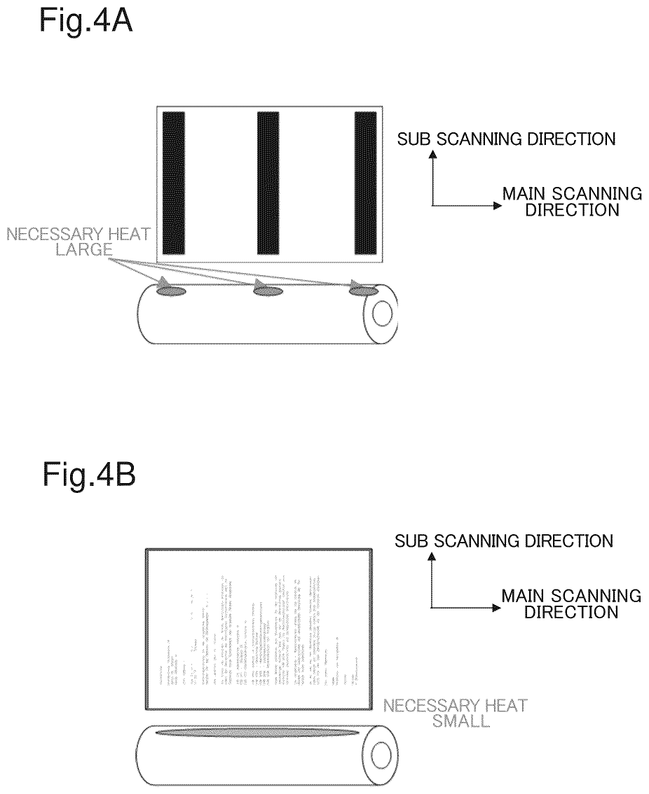

For example, when solid strips respectively expressing CMYK colors are printed as shown in FIG. 4A, a large amount of toner is deposited along the sub scanning direction over the entire page, at the position along the main scanning direction. Accordingly, a large amount of heat is required for the fixing operation, and therefore the temperature of the fixing device 13 has to be raised. In contrast, in the case of a document written in black letters as shown in FIG. 4B, the amount of the toner deposited along the sub scanning direction over the entire page, at the position along the main scanning direction, is small. Accordingly, the heat amount required for the fixing operation is small, and therefore the temperature of the fixing device 13 can be lowered.

For example, when the block size is set to 5.4 mm×5.4 mm, and when the image data includes a solid patch having a width equal to or wider than two blocks in the main scanning direction, a maximum coverage rate, among the coverage rates along the sub scanning direction over the entire page, at the plurality of main scanning positions, does not vary, irrespective of the positional relation between the solid patch and the blocks in the main scanning direction. In contrast, when the image data includes a solid patch having a width narrower than one block in the main scanning direction, a maximum coverage rate, among the coverage rates along the sub scanning direction over the entire page, at the plurality of main scanning positions, may vary by twice at maximum (50% at maximum), depending on the positional relation between the solid patch and the blocks in the main scanning direction. Further, when the image data includes a solid patch having a width equal to or wider than one block, but narrower than two blocks in the main scanning direction, a maximum coverage rate, among the coverage rates along the sub scanning direction over the entire page, at the plurality of main scanning positions, may vary by “100−(number of blocks of solid patch in the main scanning direction)/2×100(%)” at maximum, depending on the positional relation between the solid patch and the blocks in the main scanning direction. For example, in the case where the width of the solid patch in the main scanning direction corresponds to 1.5 blocks, the patch is divided into 0.75 block and 0.75 block, when the block boundary falls on the center of the solid patch, and into one block and 0.5 block, when the block boundary falls on the position of ⅔. Accordingly, the maximum coverage rate differs by 25%, between the former and the latter cases. Therefore, it is not desirable to use the coverage rate as a control parameter of the fixing temperature of the fixing device 13.

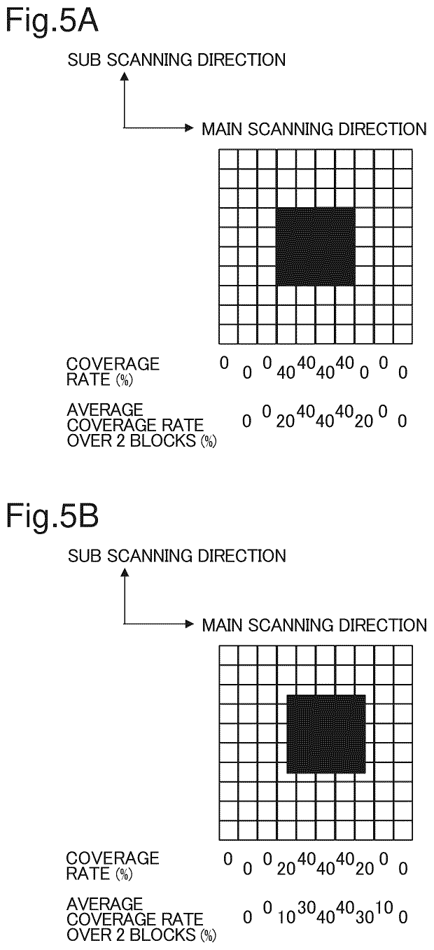

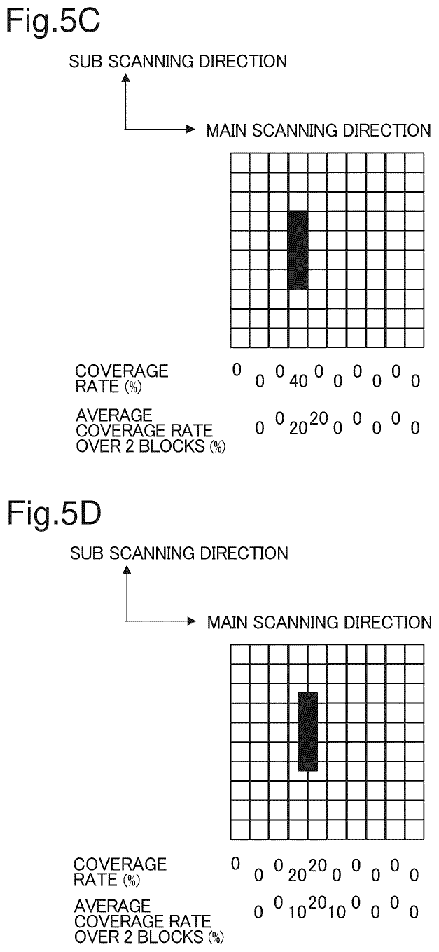

In the case where the image data is divided into 10 blocks in the main scanning direction (N) and 10 blocks in the sub scanning direction (M), when the solid patch has a size of 27 mm×27 mm, with the width in the main scanning direction corresponding to four blocks, a maximum coverage rate, among the coverage rates along the sub scanning direction over the entire page, at the plurality of main scanning positions, is 40% which does not vary, as shown in FIG. 5A and FIG. 5B. In contrast, when the solid patch has a width of 5.4 mm corresponding to one block in the main scanning direction, a maximum coverage rate becomes 40(%), when the solid patch does not stride over the block boundary in the main scanning direction as shown in FIG. 5C, but 20(%), when the solid patch strides over the block boundary at its center in the main scanning direction, as shown in FIG. 5D. In FIG. 5A to FIG. 5D, the smallest squares each correspond to a block.

For example, in the case of the solid patch having a size of 27 mm×27 mm, in other words the width in the main scanning direction wider than two blocks, a maximum average coverage rate, among the average coverage rates taken from two positions continuous with each other in the main scanning direction, is 40(%), as shown in FIG. 5A and FIG. 5B. In the case of the solid patch having a size of 5.4 mm×27 mm, in other words the width in the main scanning direction narrower than two blocks, a maximum average coverage rate, among the average coverage rates taken from two positions continuous with each other in the main scanning direction, is 20(%), as shown in FIG. 5C, FIG. 5D. Thus, the maximum average coverage rate, among the average coverage rates taken from two positions continuous with each other in the main scanning direction, remains unchanged, irrespective of the positional relation between the solid patch and the blocks in the main scanning direction. Therefore, the average coverage rate is appropriate as a control parameter of the fixing temperature of the fixing device 13.

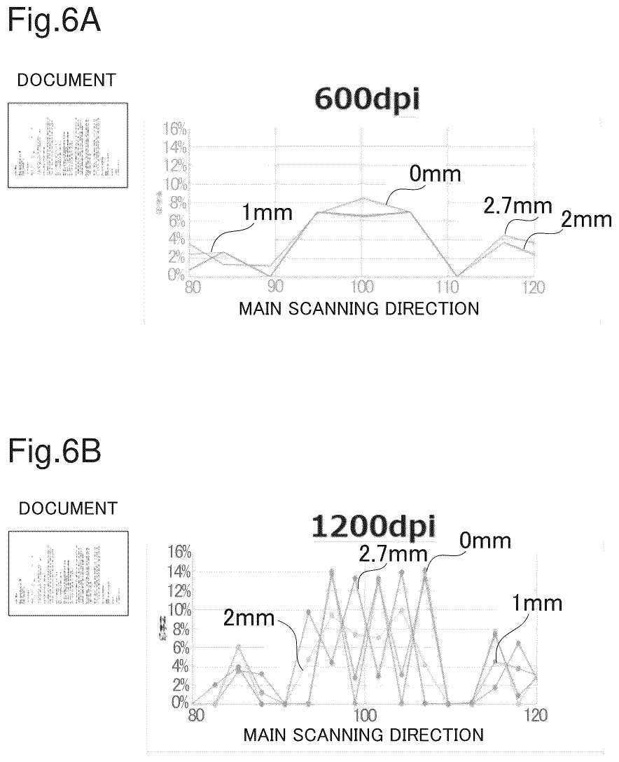

When the block size is set to 128×128 pixels, a maximum value of the average coverage rate, taken from two positions continuous with each other in the main scanning direction, barely fluctuates in the case of 600 dpi as shown in FIG. 6A, irrespective of the positional relation between the document image and the blocks, but largely fluctuates in the case of 1200 dpi as shown in FIG. 6B, depending on the positional relation between the document image and the blocks. Thus, it is difficult to properly control the fixing temperature of the fixing device 13, on the basis of the data resolution of the image data. In FIG. 6A and FIG. 6B, 0 mm represents the data of a predetermined document image, and 1 mm, 2 mm, and 2.7 mm represent the data of the document image shifted in the main scanning direction by 1 mm, 2 mm, and 2.7 mm, respectively, from the document image of 0 mm.

The mentioned drawback related to the data resolution of the image data can be resolved, for example, by exchanging the order of a pixel value counter 193 and a resolution converter 196, in the configuration shown in FIG. 3. However, the fixing temperature of the fixing device 13 is unable to be determined in time for executing the control of the fixing temperature of the fixing device 13. To execute the control of the fixing temperature of the fixing device 13 after the determination thereof, the standby time has to be prolonged, which disables high-speed operation. Alternatively, providing another resolution converter to the configuration shown in FIG. 3, and branching the pixel value counter 193 from the pipeline may also resolve the mentioned drawback. In this case, however, additional hardware has to be prepared. Further, moving the resolution converter 196 to the position immediately before the pixel value counter 193, in the configuration shown in FIG. 3, may also resolve the mentioned drawback. However, the rotator/aggregator 195 inevitably has to execute a high-resolution process, and therefore a high-level performance is required.

In the case where the block size is 128×128 pixels, 1200 dpi is too fine to suppress the fluctuation in maximum coverage rate in the sub scanning direction, while 600 dpi is appropriate for controlling the fixing temperature of the fixing device 13. Therefore, calculating the average value on the basis of a large block, formed by grouping a predetermined number of blocks corresponding to the data resolution of the image data, enables the fixing temperature of the fixing device 13 to be properly controlled, without incurring the drawbacks arising from the aforementioned three measures.

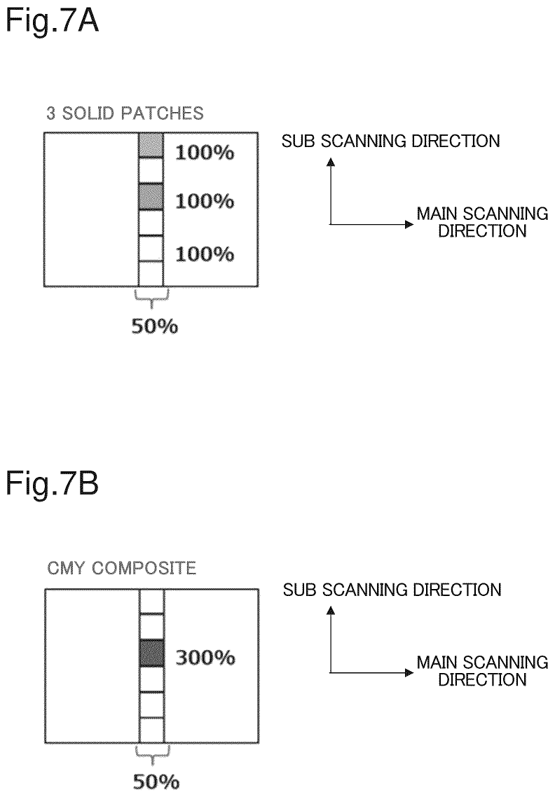

In the case of color printing, comparing between the case where, for example, respective solid patches of CMK colors are located at different positions in the sub scanning direction, at the same position along the main scanning direction as shown in FIG. 7A, and the case where the solid patches of the CMK colors are located at the same position in the sub scanning direction, at the same position along the main scanning direction as shown in FIG. 7B, although the maximum coverage rate along the sub scanning direction over the entire page, at the position along the main scanning direction becomes 50(%) which is the same in the both cases, the maximum coverage rate with respect to the blocks is 100(%) in the former case, and 300(%) in the latter case. Accordingly, the heat amount required for the fixing operation is different.

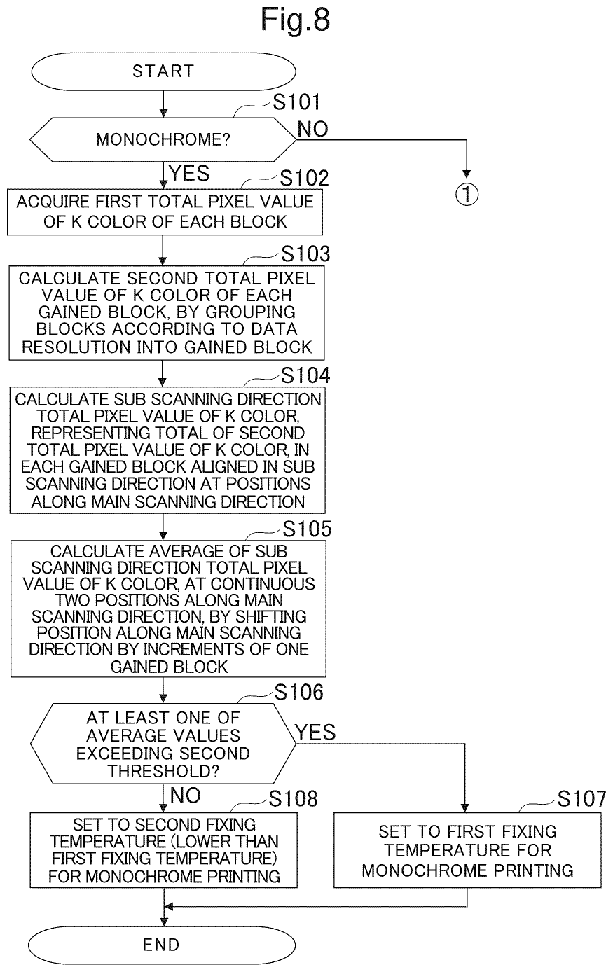

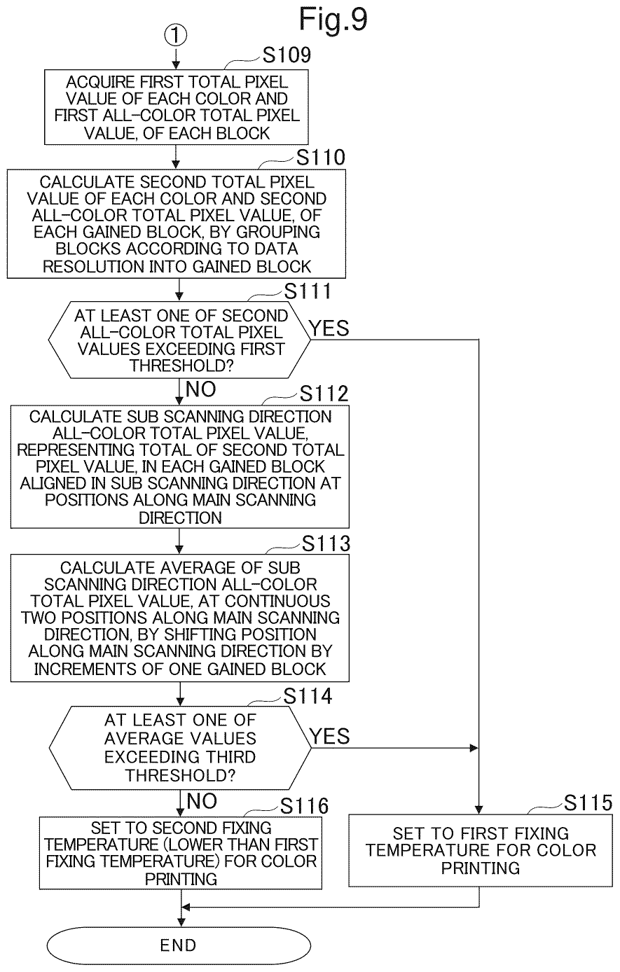

On the premise of the above, the fixing temperature of the fixing device 13 is determined, through the process according to flowcharts shown in FIG. 8 and FIG. 9.

### Configuration of System Controller 190

The system controller 190 includes a processor, a random-access memory (RAM), and a read-only memory (ROM). The processor is, for example, a central processing unit (CPU), a micro processing unit (MPU), or an application specific integrated circuit (ASIC).

The system controller 190 acts as an image generator 191, a color converter 192, a pixel value counter 193, a count value transferer 194, a rotator/aggregator 195, a resolution converter 196, and a screen processor 197, when the processor executes a control program stored in the ROM or the storage device 18.

The system controller 190 may be constituted in the form of a logic circuit, instead of being realized by the operation based on the control program.

Upon receipt of a print command described in a page description language (PDL) via the communication device 22, for example from the host PC 23, the image generator 191 executes a raster image processing (RIP), to generate raster data expressed in color, on the basis of the print command. Examples of the data resolution of the raster data generated by the image data generator 191 include 600 dots per inch (dpi) and 1200 dpi. The image generator 191 divides the generated raster data into blocks of N×M pieces of a predetermined size, each constituting a unit for image processing, and stores the divided data in a page memory region of the image memory 20. The color converter 192, the pixel value counter 193, the count value transferer 195, the rotator/aggregator 195, the resolution converter 196, and the screen processor 197, which are provided subsequent to the image generator 191, execute the processing with respect to each of the blocks. The size of the block is not specifically limited. For example, when the size of one block is 128×128 pixels, and the print resolution is 600 dpi, the size of the image on the printed sheet corresponding to the block becomes 5.4×5.4 mm.

In the case of color printing, the color converter 192 generates image data of four planes, respectively corresponding to CMYK (cyan, magenta, yellow, and black) colors, on the basis of the raster data stored in the page memory region of the image memory 20, and outputs such image data to the pixel value counter 193. In the case of monochrome printing, the color converter 192 generates the image data of one plane corresponding to the K color, on the basis of the raster data, and outputs such image data to the pixel value counter 193.

In the case of color printing, the pixel value counter 193 operates as follows.

The pixel value counter 193 counts, with respect to each of the CMYK colors, the pixel value of the color, of each of a plurality of pixels included in each of the N×M pieces of blocks, on the basis of the image data of CMYK planes inputted from the color converter 192. In other words, the pixel value counter 193 acquires, with respect to each of the CMYK colors, a first total pixel value of the color, which is a total of the pixel value of the color, of each of the plurality of pixels included in each of the N×M pieces of blocks. For example, when the pixel value of each of CMYK colors of a pixel 1 included in the block is C1, M1, Y1, K1, the pixel value of each of CMYK colors of a pixel 2 is C2, M2, Y2, K2, the pixel value of each of CMYK colors of a pixel 3 is C3, M3, Y3, K3, . . . , the pixel value counter 193 sequentially counts C1, C2, C3, . . . , with respect to C color (acquires the first total pixel value C1+C2+C3+ . . . of C color), sequentially counts M1, M2, M, . . . , with respect to M color (acquires the first total pixel value M1+M2+M3+ . . . of M color), sequentially counts Y1, Y2, Y3, . . . , with respect to Y color (acquires the first total pixel value Y1+Y2+Y3+ . . . of Y color), and sequentially counts K1, K2, K3, . . . , with respect to K color (acquires the first total pixel value K1+K2+K3+ . . . of K color).

In addition, the pixel value counter 193 counts the pixel value of each of CMYK colors, of each of a plurality of pixels included in each of the N×M pieces of blocks, on the basis of the image data of CMYK planes inputted from the color converter 192. In other words, the pixel value counter 193 acquires a first all-color total pixel value (first total pixel value of all the colors), which is a total of the pixel value of each of CMYK colors, of each of the plurality of pixels included in each of the N×M pieces of blocks. For example, when the pixel value of each of CMYK colors of a pixel 1 included in the block is C1, M1, Y1, K1, the pixel value of each of CMYK colors of a pixel 2 is C2, M2, Y2, K2, the pixel value of each of CMYK colors of a pixel 3 is C3, M3, Y3, K3, . . . , the pixel value counter 193 sequentially counts C1, M1, Y1, K1, C2, M2, Y2, K2, C3, M3, Y3, K3, . . . , thereby acquiring the first all-color total pixel value C1+M1+Y1+K1+C2+M2+Y2+K2+C3+M3+Y3+K3+ . . . .

Then the pixel value counter 193 outputs the count values (first total pixel value of C color, first total pixel value of M color, first total pixel value of Y color, first total pixel value of K color, and first all-color total pixel value), with respect to each of the N×M pieces of blocks, to the count value transferer 194, in a predetermined order (e.g., in the order of C color, M color, Y color, K color, and all colors).

Further, the pixel value counter 193 stores the image data of CMYK planes inputted from the color converter 192, in the page memory region of the image memory 20.

The pixel value counter 193 operates as described above, in the case of color printing.

In the case of monochrome printing, the pixel value counter 193 operates as follows.

The pixel value counter 193 counts the pixel value of K color, of each of a plurality of pixels included in each of the N×M pieces of blocks, on the basis of the image data of K plane inputted from the color converter 192. In other words, the pixel value counter 193 acquires a first total pixel value of K color, which is a total of the pixel value of K color, of each of the plurality of pixels included in each of the N×M pieces of blocks. For example, when the pixel value of K color of a pixel 1 included in the block is K1, the pixel value of K color of a pixel 2 is K2, the pixel value of K color of a pixel 3 is K3, . . . , the pixel value counter 193 sequentially counts K1, K2, K3, . . . , with respect to K color (acquires the first total pixel value K1+K2+K3+ . . . of K color).

Then the pixel value counter 193 outputs the count value (first total pixel value of K color), with respect to each of the N×M pieces of blocks, to the count value transferer 194, in a predetermined order.

Further, the pixel value counter 193 stores the image data of K plane inputted from the color converter 192, in the page memory region of the image memory 20.

The pixel value counter 193 operates as described above, in the case of monochrome printing.

Here, the pixel value counter 193 may include a counter circuit for acquiring the first total pixel value of C color, a counter circuit for acquiring the first total pixel value of M color, a counter circuit for acquiring the first total pixel value of Y color, a counter circuit for acquiring the first total pixel value of K color, and a counter circuit for acquiring the first all-color total pixel value. The number of bits of each counter circuit may be determined on the basis of the number of gradations of the pixel, and the number of pixels included in a block.

In the case of color printing, the count values of each of the N×M pieces of blocks (first total pixel value of C color, first total pixel value of M color, first total pixel value of Y color, first total pixel value of K color, and first all-color total pixel value) are inputted to the count value transferer 194 from the pixel value counter 193, in a predetermined order. The count value transferer 194 stores the count values of the blocks, inputted from the pixel value counter 193 in the predetermined order, in a static random-access memory (SRAM) of the system controller 190, in the order that the count values have been inputted. Then the count value transferer 194 outputs an interruption signal to the print controller 110, upon having stored the count values of a predetermined number of blocks, in the SRAM. Upon receipt of the interruption signal, the print controller 110 collectively retrieves the count values of the predetermined number of blocks stored in the SRAM, and stores the count values of the predetermined number of blocks retrieved, in continuous addresses of the image memory 20, in the order that the count values have been stored in the SRAM.

In the case of monochrome printing, the count value of each of the N×M pieces of blocks (first total pixel value of K color) is inputted to the count value transferer 194 from the pixel value counter 193, in a predetermined order. The count value transferer 194 stores the count values of the blocks, inputted from the pixel value counter 193 in the predetermined order, in the SRAM of the system controller 190, in the order that the count values have been inputted. Then the count value transferer 194 outputs an interruption signal to the print controller 110, upon having stored the count values of a predetermined number of blocks, in the SRAM. Upon receipt of the interruption signal, the print controller 110 collectively retrieves the count values of the predetermined number of blocks stored in the SRAM, and stores the count values of the predetermined number of blocks retrieved, in continuous addresses of the image memory 20, in the order that the count values have been stored in the SRAM.

With the mentioned arrangement, the number of times of retrieval can be reduced, compared with the case where the print controller 110 retrieves the count value with respect to each of the blocks. In addition, an increase in hardware resource can be suppressed, compared with the case where a buffer of a size that can store the count value of all the blocks (i.e., capable of supporting the image data of the maximum size) is prepared in advance. Further, since the count values are stored in the continuous addresses of the image memory 20 in the predetermined order, the fixing controller 123 to be subsequently described can, for example, calculate the total of the total pixel value of N pieces of blocks aligned in the sub scanning direction at a position along the main scanning direction, without the need to prepare single-purpose hardware resource for identifying the block position.

The rotator/aggregator 195 looks up the image data of the CMYK planes stored in the page memory region of the image memory 20 in the case of color printing, or the image data of the K plane stored in the page memory region of the image memory 20 in the case of monochrome printing, and retrieves the image data representing each block from the image memory 20, while controlling the order of retrieval, and then executes at least one of rotation and aggregation, by sorting the retrieved image data representing each block, according to the settings received through the operation device 16.

The resolution converter 196 converts, with respect to the image data representing each block, the data resolution of the raster data generated by the image generator 191, to the resolution in which the engine controller 120 actually executes the printing operation, in the order that the image data has been processed by the rotator/aggregator 195. For example, the resolution converter 196 performs multiplying conversion, such as from 600 dpi to 1200 dpi. Here, the conversion of the resolution by the resolution converter 193 is different from minute magnification that the user specifies for the printing operation. In general, the minute magnification specified by the user is transmitted from the print controller 110 to the processor of the image generator 191, so that the processor performs the minute magnification into the size of the sheet P, through margin adjustment.

The screen processor 197 executes screen processing with respect to the image data representing each block, in the order that the processing by the resolution converter 196 finished. The screen processor 197 converts the image data representing each block corresponding to one page that has undergone the screen processing into final drawing data, and saves the drawing data in the image memory 20 acting as a buffer.

### Configuration of Print Controller 110

The print controller 110 includes a processor, a RAM, and a ROM. The print controller 110 controls the operation of the engine controller 120, when a control program stored in the ROM or the storage device 18 is executed by the processor.

For example, the print controller 110 outputs various types of command signals for executing the image forming operation, to the engine controller 120. The print controller 110 may be constituted in the form of a logic circuit, instead of being realized by the operation based on the control program.

### Configuration of Engine Controller 120

The engine controller 120 controls the image forming operation of the image forming apparatus 1. The engine controller 120 includes a processor, a RAM, and a ROM.

The engine controller 120 acts as a print position adjuster 121, a light emission controller 122, a fixing controller 123, a transport controller 124, and an image forming controller 125 as shown in FIG. 3, when the processor executes a control program stored in the ROM or the storage device 18.

The engine controller 120 may be constituted in the form of a logic circuit, instead of being realized by the operation based on the control program.

The print position adjuster 121 retrieves the drawing data from the image memory 20, and executes at least one of an image position adjustment process and a margin assignment process with respect to the drawing data retrieved, according to the settings received through the operation device 16.

The light emission controller 122 controls the light emission by the LSU 12A, by switching on or off a lighting signal, on the basis of the drawing data that has undergone at least one of the image position adjustment process and the margin assignment process.

The fixing controller 123 executes the fixing temperature control program for controlling the fixing temperature of the fixing device 13, stored in the storage device 18. The N×M pieces of blocks are arranged such that N pieces are aligned in the transport direction of the sheet P by the transport device 17 (sub scanning direction), and M pieces are aligned in the orthogonal direction (main scanning direction), orthogonal to the transport direction. In the case of color printing, since the first total pixel value of each block (first total pixel value of C color, first total pixel value of M color, first total pixel value of Y color, first total pixel value of K color, and first all-color total pixel value) are stored in the continuous addresses of the image memory 20 in the predetermined order, the fixing controller 123 can retrieve the first total pixel value of each of the blocks from the image memory 20, in the predetermined order. In the case of monochrome printing, since the first total pixel value of K color in each block is stored in the continuous addresses of the image memory 20 in the predetermined order, the fixing controller 123 can retrieve the first total pixel value of K color of each block from the image memory 20, in the predetermined order.

In the case of color printing, the fixing controller 123 operates as follows.

The fixing controller 123 defines A×B pieces of object blocks in the N×M pieces of blocks, by grouping a predetermined number of blocks, according to the data resolution of the image data (raster data generated by the image generator 191), into one object block. The A×B pieces of object blocks are arranged such that A pieces are aligned in the direction in which N pieces of the N×M pieces of blocks are aligned (sub scanning direction), and B pieces are aligned in the direction in which M pieces of the N×M pieces of blocks are aligned (main scanning direction). In this embodiment, when the data resolution of the image data is P times as high as a predetermined data resolution (hereinafter, “standard data resolution” where appropriate), the fixing controller 123 designates P×P pieces of blocks of a predetermined number, arranged such that P pieces are aligned in the sub scanning direction and P pieces are aligned in the main scanning direction, as one object block. For example, when the data resolution of the image data is 1200 dpi while the standard data resolution is 600 dpi, the fixing controller 123 designates four blocks, including two blocks aligned in the transport direction and two blocks aligned in the orthogonal direction, as one object block. As another example, when the data resolution of the image data is 2400 dpi while the standard data resolution is 600 dpi, the fixing controller 123 designates 16 blocks, including four blocks aligned in the transport direction and four blocks aligned in the orthogonal direction, as one object block. Further, in the case where the data resolution of the image data is 1200 dpi, when the standard data resolution is 600 dpi, the fixing controller 123 designates one block, consisting of one block located along the transport direction and the orthogonal direction, as one object block. Here, the standard data resolution may be different from 600 dpi, and the data resolution of the image data to be inputted may also be different from 600 dpi, 1200 dpi, or 2400 dpi.

The A×B pieces of object blocks are, as described above, arranged such that A pieces are aligned in the sub scanning direction (transport direction of the sheet P by the transport device 17), and B pieces are aligned in the main scanning direction (orthogonal direction orthogonal to the transport direction of the sheet P by the transport device 17).

The fixing controller 123 acquires, from the image memory 20, the first total pixel value of each of CMYK colors and the first all-color total pixel value, of each of the N×M pieces of blocks, stored in the image memory 20.

The fixing controller 123 calculates, with respect to each of the CMYK colors, the second total pixel value of the color, which is the total of the first total pixel value of the color, of each of the predetermined number of blocks, included in each of the A×B pieces of object blocks, and also the second all-color total pixel value, which is the total of the first all-color total pixel value of each of the predetermined number of blocks included in the object block.

When at least one of the second all-color total pixel values of the A×B pieces of object blocks exceeds a predetermined threshold (hereinafter, “first threshold” where appropriate), the fixing controller 123 determines the fixing temperature of the fixing device 13, on the basis of the second all-color total pixel value of the A×B pieces of object blocks. In this embodiment, the fixing controller 123 sets the fixing temperature to a predetermined fixing temperature (hereinafter, “first fixing temperature for color printing”, where appropriate).

When none of the second all-color total pixel values of the A×B pieces of object blocks exceed the first threshold, the fixing controller 123 calculates, with respect to each of CMYK colors, a sub scanning direction total pixel value of the color which is the total of the second total pixel value of each of A pieces of object blocks, aligned along the sub scanning direction, at the position of the k-th object block along the main scanning direction, k being an integer between 1 and B, both ends inclusive, and then calculates a sub scanning direction all-color total pixel value, which is the total of the sub scanning direction total pixel value of each of CMYK colors, calculated as above, of the position of the k-th block. For example, when the second total pixel value of each of CMYK colors, of the object block 1 aligned in the sub scanning direction at the position of the k-th object block along the main scanning direction, is Ct1, Mt1, Yt1, Kt1, the second total pixel value of each of CMYK colors of the object block 2 is Ct2, Mt2, Yt2, Kt2, and the second total pixel value of each of CMYK colors of the object block 3 is Ct3, Mt3, Yt3, Kt3, . . . , the fixing controller 123 calculates Ct1+Ct2+Ct3+ . . . as the sub scanning direction total pixel value of C color, calculates Mt1+Mt2+Mt3+ . . . as the sub scanning direction total pixel value of M color, calculates Yt1+Yt2+Yt3+ . . . as the sub scanning direction total pixel value of Y color, and calculates Kt1+Kt2+Kt3+ . . . as the sub scanning direction total pixel value of K color, and further calculates Ct1+Ct2+Ct3+ . . . +Mt1+Mt2+Mt3+ . . . +Yt1+Yt2+Yt3+ . . . +Kt1+Kt2+Kt3+ . . . , as the sub scanning direction all-color total pixel value.

The fixing controller 123 calculates a b-th average value, which is the average of the sub scanning direction all-color total pixel value of the position of the b-th object block along the main scanning direction, b being an integer between 1 and B−1, both ends inclusive, and the sub scanning direction all-color total pixel value of the position of the (b+1)th object block along the main scanning direction. The fixing controller 123 executes a fixing temperature setting process, including setting the fixing temperature of the fixing device 13 to a predetermined first fixing temperature for color printing, when at least one of the b-th average values exceeds a predetermined threshold (hereinafter, “third threshold” where appropriate), and setting the fixing temperature of the fixing device 13 to a fixing temperature, predetermined according to the b-th average value, and lower than the first fixing temperature for color printing, when none of the b-th average values exceed the third threshold. In this embodiment, when at least one of the first average value to the (B−1)th average value exceeds the third threshold, the fixing controller 123 sets the fixing temperature to the first fixing temperature for color printing, and when none of the first average value to the (B−1)th average value exceed the third threshold, the fixing controller 123 sets the fixing temperature to a predetermined second fixing temperature for color printing, lower than the first fixing temperature for color printing. The fixing controller 123 then controls the fixing temperature of the fixing device 13, on the basis of the fixing temperature determined as above.

The fixing controller 123 operates as described above, in the case of color printing.

In the case of monochrome printing, the fixing controller 123 operates as follows.

Like the case of color printing, the fixing controller 123 defines A×B pieces of object blocks in the N×M pieces of blocks, by grouping a predetermined number of blocks, according to the data resolution of the image data (raster data generated by the image generator 191), into one object block. The A×B pieces of object blocks are arranged such that A pieces are aligned in the direction in which N pieces of the N×M pieces of blocks are aligned (sub scanning direction), and B pieces are aligned in the direction in which M pieces of the N×M pieces of blocks are aligned (main scanning direction). In this embodiment, when the data resolution of the image data is P times as high as the standard data resolution, the fixing controller 123 designates P×P pieces of blocks of a predetermined number, arranged such that P pieces are aligned in the sub scanning direction and P pieces are aligned in the main scanning direction, as one object block.

The A×B pieces of object blocks are, as described above, arranged such that A pieces are aligned in the sub scanning direction (transport direction of the sheet P by the transport device 17), and B pieces are aligned in the main scanning direction (orthogonal direction orthogonal to the transport direction of the sheet P by the transport device 17).

The fixing controller 123 acquires, from the image memory 20, the first total pixel value of K color of each of the N×M pieces of blocks, stored in the image memory 20.

The fixing controller 123 calculates the second total pixel value of K color, which is the total of the first total pixel value of K color, of each of the predetermined number of blocks, included in the object block.

The fixing controller 123 calculates a sub scanning direction total pixel value of K color, which is the total of the second total pixel value of K color of each of A pieces of object blocks, aligned in the sub scanning direction at the position of the k-th object block along the main scanning direction, k being an integer between 1 and B, both ends inclusive.

The fixing controller 123 calculates the b-th average value, which is the average of the sub scanning direction total pixel value of K color, of the position of the b-th object block along the main scanning direction, b being an integer between 1 and B−1, both ends inclusive, and the sub scanning direction total pixel value of the position of the (b+1)th object block along the main scanning direction. The fixing controller 123 executes the fixing temperature setting process, including setting the fixing temperature of the fixing device 13 to a predetermined first fixing temperature for monochrome printing, when at least one of the b-th average values exceeds a predetermined threshold (hereinafter, “second threshold” where appropriate), and setting the fixing temperature of the fixing device 13 to a fixing temperature, predetermined according to the b-th average value, and lower than the first fixing temperature for monochrome printing, when none of the b-th average values exceed the second threshold. In this embodiment, when at least one of the first average value to the (B−1)th average value exceeds the second threshold, the fixing controller 123 sets the fixing temperature to the first fixing temperature for monochrome printing, and when none of the first average value to the (B−1)th average value exceed the second threshold, the fixing controller 123 sets the fixing temperature to a predetermined second fixing temperature for monochrome printing, lower than the first fixing temperature for monochrome printing. The fixing controller 123 then controls the fixing temperature of the fixing device 13, on the basis of the fixing temperature determined as above.

Here, there may be cases where the image forming apparatus 1 performs aggregated printing of a plurality of pages, or printing of an image rotated by 90 degrees. The fixing controller 123 can modify the mentioned processes according to the setting detail for the aggregated printing or printing of the image rotated by 90 degrees, to accept the setting for the aggregated printing or printing of the image rotated by 90 degrees, via the operation device 16. As described above, the image data is divided into N×M pieces of blocks of a predetermined size, such that N pieces are aligned in a predetermined first direction, and M pieces are aligned in a second direction orthogonal to the first direction. In addition, A×B pieces of object blocks are defined in the N×M pieces of blocks, by grouping a predetermined number of the blocks in the N×M pieces of blocks, according to the data resolution of the image data, into one object block, such that A pieces are aligned in the predetermined first direction, and B pieces are aligned in the second direction orthogonal to the first direction. For example, in the case of printing of the image rotated by 90 degrees, the first direction and the second direction respectively correspond to the orthogonal direction, orthogonal to the transport direction of the sheet P by the transport device 17, and the transport direction. Therefore, the mentioned process may be similarly performed, with the second direction and the first direction respectively defined as the sub scanning direction and the main scanning direction. Thus, in the case of printing of the image rotated by 90 degrees, “M” corresponds to “N” in the disclosure, “N” corresponds to “M” in the disclosure, “B” corresponds to “A” in the disclosure, and “A” corresponds to “B” in the disclosure.

The transport controller 124 controls the operation of the transport device 17, thereby executing the transport of the sheet P.

The image forming controller 125 controls the image forming operation of the image forming device 12. To be more specific, the image forming controller 125 causes the image forming device 12 to generate a toner image, by developing an electrostatic latent image formed on the surface of a photoconductor drum, through the light emission control performed by the light emission controller 122, and to transfer the generated toner image to the sheet P transported to the image forming position.

### Determination of Fixing Temperature

FIG. 8 and FIG. 9 are flowcharts each showing the setting process of the fixing temperature of the fixing device 13, performed by the fixing controller 123 shown in FIG. 3. The setting process of the fixing temperature of the fixing device 13 shown in FIG. 8 and FIG. 9, is performed by the fixing controller 123 according to the fixing temperature control program stored in the storage device 18.

The fixing controller 123 decides whether monochrome printing is to be performed, on the basis of the setting detail received via the operation device 16 (step S101).

Upon deciding at step S101 that monochrome printing is to be performed (YES at S101), the fixing controller 123 proceeds to step S102.

In the case of monochrome printing, the pixel value counter 193 counts the pixel value of K color, of each of a plurality of pixels included in each of the N×M pieces of blocks, on the basis of the image data of K plane inputted from the color converter 192. In other words, the pixel value counter 193 acquires the first total pixel value of K color, which is the total of the pixel value of K color, of each of the plurality of pixels included in each of the N×M pieces of blocks. The first total pixel value of K color of each of the N×M pieces of blocks is stored in the image memory 20, through the operation performed by the count value transferer 194 and the print controller 110.

The fixing controller 123 acquires the first total pixel value of K color of each of the N×M pieces of blocks, from the image memory 20 (step S102).

The fixing controller 123 defines A×B pieces of object blocks in the N×M pieces of blocks, by grouping a predetermined number of blocks, according to the data resolution of the image data (raster data generated by the image generator 191), into one object block. The A×B pieces of object blocks are arranged such that A pieces are aligned in the direction in which N pieces of the N×M pieces of blocks are aligned (sub scanning direction), and B pieces are aligned in the direction in which M pieces of the N×M pieces of blocks are aligned (main scanning direction).

After step S102, the fixing controller 123 calculates the second total pixel value of K color, which is the total of the first total pixel value of K color, of each of the predetermined number of blocks, included in the object block (step S103).

After step S103, the fixing controller 123 calculates the sub scanning direction total pixel value of K color, which is the total of the second total pixel value of K color of each of A pieces of object blocks, aligned in the sub scanning direction at the position of the k-th object block along the main scanning direction, k being an integer between 1 and B, both ends inclusive (step S104).

After step S104, the fixing controller 123 calculates the b-th average value, which is the average of the sub scanning direction total pixel value of K color, of the position of the b-th object block along the main scanning direction, b being an integer between 1 and B−1, both ends inclusive, and the sub scanning direction total pixel value of the position of the (b+1)th object block along the main scanning direction (step S105). In this embodiment, the fixing controller 123 calculates the b-th average value, which is the average of the sub scanning direction total pixel value of K color at the position of the b-th object block along the main scanning direction (b being an integer between 1 and B−1, both ends inclusive), and the sub scanning direction total pixel value of K color at the position of the (b+1)th object block along the main scanning direction, shifting the calculation position by increments of one object block.

After step S105, the fixing controller 123 decides whether at least one of the first average value to the (B−1)th average value exceeds the second threshold (step S106). Upon deciding at step S106 that at least one of the first average value to the (B−1)th average value exceeds the second threshold (YES at S106), the fixing controller 123 sets the fixing temperature of the fixing device 13 to the first fixing temperature for monochrome printing (step S107). In contrast, upon deciding at step S106 that none of the first average value to the (B−1)th average value exceed the second threshold (NO at S106), the fixing controller 123 sets the fixing temperature of the fixing device 13 to the second fixing temperature for monochrome printing, lower than the first fixing temperature for monochrome printing (step S108).

Upon deciding at step S101 that monochrome printing is not to be performed, in other words that color printing is to be performed (NO at S101), the fixing controller 123 proceeds to step S109.

In the case of color printing, the pixel value counter 193 counts, with respect to each of the CMYK colors, the pixel value of the color, of each of a plurality of pixels included in each of the N×M pieces of blocks, on the basis of the image data of CMYK planes inputted from the color converter 192. In other words, the pixel value counter 193 acquires, with respect to each of the CMYK colors, the first total pixel value of the color, which is the total of the pixel value of the color, of each of the plurality of pixels included in each of the N×M pieces of blocks. In addition, the pixel value counter 193 counts the pixel value of each of CMYK colors, of each of a plurality of pixels included in each of the N×M pieces of blocks, on the basis of the image data of CMYK planes inputted from the color converter 192. In other words, the pixel value counter 193 acquires the first all-color total pixel value (first total pixel value of all the colors), which is the total of the pixel value of each of CMYK colors, of each of the plurality of pixels included in each of the N×M pieces of blocks. The first total pixel value of each of CMYK colors, and the first all-color total pixel value, of each of the N×M pieces of blocks, are stored in the image memory 20, through the operation performed by the count value transferer 194 and the print controller 110.

The fixing controller 123 acquires, from the image memory 20, the first total pixel value of each of CMYK colors and the first all-color total pixel value, of each of the N×M pieces of blocks, stored in the image memory 20 (step S109).

The fixing controller 123 defines A×B pieces of object blocks in the N×M pieces of blocks, by grouping a predetermined number of blocks, according to the data resolution of the image data (raster data generated by the image generator 191), into one object block. The A×B pieces of object blocks are arranged such that A pieces are aligned in the direction in which N pieces of the N×M pieces of blocks are aligned (sub scanning direction), and B pieces are aligned in the direction in which M pieces of the N×M pieces of blocks are aligned (main scanning direction).

After step S109, the fixing controller 123 calculates, with respect to each of the CMYK colors, the second total pixel value of the color, which is the total of the first total pixel value of the color, of each of the predetermined number of blocks, included in each of the A×B pieces of object blocks, and also the second all-color total pixel value, which is the total of the first all-color total pixel value of each of the predetermined number of blocks included in the object block (step S110).

After step S110, the fixing controller 123 decides whether at least one of the second all-color total pixel values exceeds the first threshold (step S111). Upon deciding at step S111 that at least one of the second all-color total pixel values exceeds the first threshold (YES at S111), the fixing controller 123 sets the fixing temperature of the fixing device 13 to the first fixing temperature for color printing (step S115).

In contrast, upon deciding at step S111 that none of the second all-color total pixel values exceed the first threshold (NO at S111), the fixing controller 123 proceeds to step S112.

The fixing controller 123 calculates, with respect to each of CMYK colors, the sub scanning direction total pixel value of the color which is the total of the second total pixel value of each of A pieces of object blocks, aligned along the sub scanning direction, at the position of the k-th object block along the main scanning direction, k being an integer between 1 and B, both ends inclusive, and then calculates the sub scanning direction all-color total pixel value, which is the total of the sub scanning direction total pixel value of each of CMYK colors, calculated as above, of the position of the k-th block (step S112).

After step S112, the fixing controller 123 calculates the b-th average value, which is the average of the sub scanning direction all-color total pixel value of the position of the b-th object block along the main scanning direction, b being an integer between 1 and B−1, both ends inclusive, and the sub scanning direction all-color total pixel value of the position of the (b+1)th object block along the main scanning direction (step S113). In this embodiment, the fixing controller 123 calculates the b-th average value, which is the average of the sub scanning direction all-color total pixel value at the position of the b-th object block along the main scanning direction (b being an integer between 1 and B−1, both ends inclusive), and the sub scanning direction all-color total pixel value at the position of the (b+1)th object block along the main scanning direction, shifting the calculation position by increments of one object block.

After step S113, the fixing controller 123 decides whether at least one of the first average value to the (B−1)th average value exceeds the third threshold (step S114). Upon deciding at step S114 that at least one of the first average value to the (B−1)th average value exceeds the third threshold (YES at S114), the fixing controller 123 sets the fixing temperature of the fixing device 13 to the first fixing temperature for color printing (step S115). In contrast, upon deciding at step S114 that none of the first average value to the (B−1)th average value exceed the third threshold (NO at S114), the fixing controller 123 sets the fixing temperature of the fixing device 13 to the second fixing temperature for color printing, lower than the first fixing temperature for color printing (step S116).

### Operation

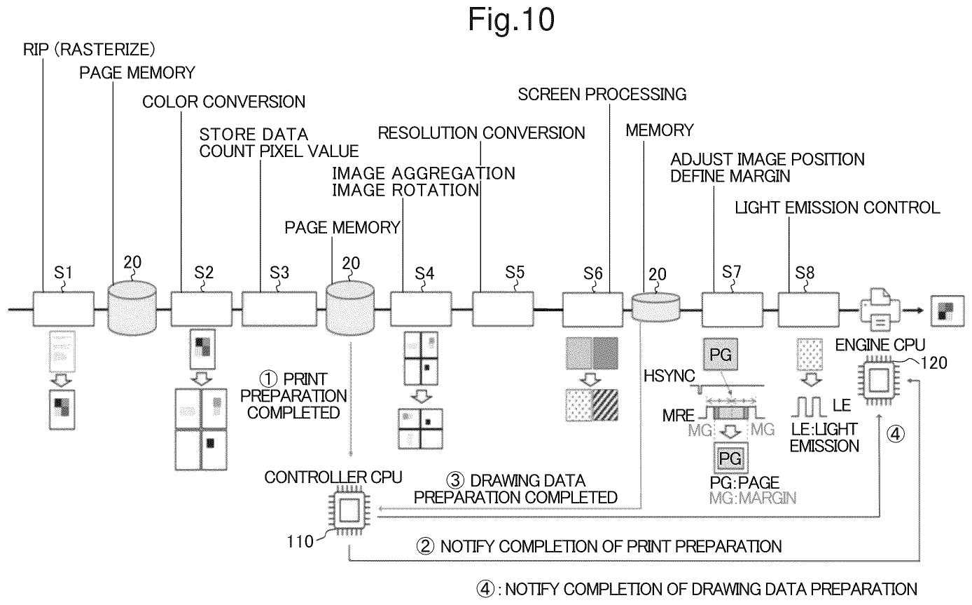

Referring primarily to FIG. 10, an image formation flow including steps S1 to S8 will be described hereunder.

### 1. Image Processing and Sheet Transport

The system controller 190, the print controller 110, and the engine controller 120 execute the image processing and the sheet transport in parallel, as specified below.

Upon receipt of a print command described in the page description language (PDL) via the communication device 22, for example from the host PC 23 at step S1, the image generator 191 executes the RIP, to generate raster data expressed in color, on the basis of the print command. The image generator 191 divides the generated raster data into blocks of N×M pieces of a predetermined size, each constituting a unit for image processing, and saves the blocks in the page memory region of the image memory 20.

At step S2, the color converter 192 generates, in the case of color printing, the image data of 4 planes, respectively corresponding to the CMYK colors, on the basis of the raster data stored in the page memory region of the image memory 20, and outputs the generated image data to the pixel value counter 193. In the case of monochrome printing, the color converter 192 generates the image data of one plane corresponding to K color, on the basis of the raster data, and outputs the generated image data to the pixel value counter 193.

At step S3, the pixel value counter 193 saves the image data of the CMYK planes, inputted from the color converter 192, in the page memory region of the image memory 20, in the case of color printing. At the time point that the image data of the 4 planes has been saved in the page memory region of the image memory 20, the pixel value counter 193 outputs a print preparation completion signal, to the print controller 110.

In the case of monochrome printing, the pixel value counter 193 saves the image data of the K plane, inputted from the color converter 192, in the page memory region of the image memory 20. At the time point that the image data of one plane has been saved in the page memory region of the image memory 20, the pixel value counter 193 outputs a print preparation completion signal, to the print controller 110.

Upon receipt of the print preparation completion signal, the print controller 110 notifies the engine controller 120 that the preparation for printing has been completed, in both cases of color printing and monochrome printing. Upon receipt of the notice of the completion of preparation, the transport controller 124 of the engine controller 120 causes the transport device 17 to start transporting the sheet P.

At step S4, the rotator/aggregator 195 looks up the image data of the CMYK planes stored in the page memory region of the image memory 20, in the case of color printing, or the image data of the K plane stored in the page memory region of the image memory 20, in the case of monochrome printing, and retrieves the image data representing each block from the image memory 20 while controlling the order of retrieval, and then executes at least one of the rotation and aggregation, by sorting the retrieved block data according to the settings received through the operation device 16.

At step S5, the resolution converter 196 converts, with respect to the image data representing each block, the data resolution of the raster data generated by the image generator 191, to the resolution in which the engine controller 120 actually performs the printing operation, in the order that the rotator/aggregator 195 has finished the operation.

At step S6, the screen processor 197 executes the screen processing with respect to the image data representing each block, in the order that the resolution converter 196 finished the processing. The screen processor 197 converts the image data representing each block, corresponding to one page that has undergone the screen processing, into final drawing data, and saves the drawing data in the image memory 20 acting as a buffer.

At the time point that the drawing data has been saved in the image memory 20, the screen processor 197 outputs a drawing data preparation completion signal to the print controller 110. When the drawing data preparation completion signal is inputted, the print controller 110 notifies the engine controller 120 that the preparation of the drawing data has been completed. Upon receipt of the notice of the completion of the drawing data preparation, the transport controller 124 of the engine controller 120 causes the transport device 17 to continue with the transport of the sheet P.

### 2. Image Forming Operation

The engine controller 120 controls the image forming operation, as described hereunder.

At step S7, the print position adjuster 121 retrieves the drawing data from the image memory 20, and executes at least one of the image position adjustment process and the margin assignment process with respect to the drawing data, according to the settings received through the operation device 16.

At step S8, the light emission controller 122 controls the light emission by the LSU 12A, by switching on or off the lighting signal, on the basis of the drawing data that has undergone at least one of the image position adjustment process and the margin assignment process.

The image forming controller 125 controls the image forming operation of the image forming device 12. To be more specific, the image forming controller 125 causes the image forming device 12 to generate a toner image, by developing an electrostatic latent image formed on the surface of the photoconductor drum, through the light emission control performed by the light emission controller 122, and to transfer the generated toner image to the sheet P transported to the image forming position.

### 3. Fixing Operation

The system controller 190, the print controller 110, and the engine controller 120 control the fixing temperature and the execution of the fixing operation, as described hereunder.

In the case of color printing, at step S3 the pixel value counter 193 acquires, with respect to each of the CMYK colors, the first total pixel value, which is the total of the pixel value of the color, of each of a plurality of pixels included in each of the N×M pieces of blocks, on the basis of the image data of CMYK planes inputted from the color converter 192, and further acquires the first all-color total pixel value, which is the total of the pixel value of each of CMYK colors, of a plurality of pixels included in each of the N×M pieces of blocks. Then the pixel value counter 193 outputs the first total pixel value of C color, the first total pixel value of M color, the first total pixel value of Y color, the first total pixel value of K color, and the first all-color total pixel value, with respect to each of the N×M pieces of blocks, to the count value transferer 194 in a predetermined order.

The count value transferer 194 stores the first total pixel value of C color, the first total pixel value of M color, the first total pixel value of Y color, the first total pixel value of K color, and the first all-color total pixel value, of each of the blocks, inputted from the pixel value counter 193 in the predetermined order, in the SRAM of the system controller 190, in the order that the pixel values have been inputted. Then the count value transferer 194 outputs an interruption signal to the print controller 110, upon having stored the first total pixel value of C color, the first total pixel value of M color, the first total pixel value of Y color, the first total pixel value of K color, and the first all-color total pixel value, of a predetermined number of blocks, in the SRAM. Upon receipt of the interruption signal, the print controller 110 collectively retrieves the first total pixel value of C color, the first total pixel value of M color, the first total pixel value of Y color, the first total pixel value of K color, and the first all-color total pixel value, of the predetermined number of blocks stored in the SRAM, and stores the first total pixel value of C color, the first total pixel value of M color, the first total pixel value of Y color, the first total pixel value of K color, and the first all-color total pixel value, of the predetermined number of blocks retrieved, in continuous addresses of the image memory 20, in the order that the pixel values have been stored in the SRAM.

In the case of monochrome printing, the pixel value counter 193 acquires the first total pixel value of K color, which is the total of the pixel value of K color, of each of the plurality of pixels included in each of the N×M pieces of blocks, on the basis of the image data of K plane inputted from the color converter 192. Then the pixel value counter 193 outputs the first total pixel value of K color, with respect to each of the N×M pieces of blocks, to the count value transferer 194, in a predetermined order.

The count value transferer 194 stores the first total pixel value of K color of each of the blocks, inputted from the pixel value counter 193 in the predetermined order, in the SRAM of the system controller 190, in the order that the pixel values have been inputted. Then the count value transferer 194 outputs an interruption signal to the print controller 110, upon having stored the first total pixel value of K color of a predetermined number of blocks, in the SRAM. Upon receipt of the interruption signal, the print controller 110 collectively retrieves the first total pixel value of K color of the predetermined number of blocks stored in the SRAM, and stores the first total pixel value of K color of the predetermined number of blocks retrieved, in continuous addresses of the image memory 20, in the order that the pixel values have been stored in the SRAM.

The fixing controller 123 determines the fixing temperature of the fixing device 13, by executing the setting process of the fixing temperature of the fixing device 13 shown in FIG. 8 and FIG. 9, on the basis of the first total pixel value of each color and the first all-color total pixel value, or the first total pixel value of K color, of each of the blocks, stored in the image memory 20. Then the fixing controller 123 controls the fixing temperature of the fixing device 13 on the basis of the fixing temperature of the fixing device 13 determined as above, and fixes the toner image onto the sheet P, by heating and pressing the sheet P on which the toner image has been formed.

According to the foregoing embodiment, to determine the fixing temperature of the fixing device 13, the A×B pieces of object blocks are defined in the N×M pieces of blocks, formed by dividing the image data into a predetermined size, by grouping a predetermined number of the blocks according to the data resolution of the image data, into one object block, and the b-th average value is employed, which is the average of the total of the second total pixel value of each of the A pieces of object blocks, aligned in the sub scanning direction, or the total of the second total pixel value of each of CMYK colors of each of the A pieces of object blocks, aligned in the sub scanning direction, at the position of the b-th object block along the main scanning direction, b being an integer between 1 and B−1, both ends inclusive, and the total of the second total pixel value of each of the A pieces of object blocks, aligned in the sub scanning direction, or the total of the second total pixel value of each of CMYK colors of each of the A pieces of object blocks, aligned in the sub scanning direction, at the position of the (b+1)th object block along the orthogonal direction. The fluctuation of a largest b-th average value can be suppressed, irrespective of the positional relation between the image drawing region in the page and the block formed by dividing the image data. In addition, the fluctuation of the largest b-th average value can be suppressed, irrespective of the resolution of the image data inputted, by defining the A×B pieces of object blocks in the N×M pieces of blocks, by grouping the predetermined number of the blocks according to the data resolution of the image data, into one object block, and executing the average value calculation process on the basis of the object block. Therefore, the power consumption by the fixing device 13 can be suppressed, and the toner image can be surely fixed onto the sheet, by controlling the fixing temperature of the fixing device 13.

The heat amount required for the fixing operation differs, between the case where, for example, the respective solid patches of CMK colors are located at different positions in the sub scanning direction, at the same position along the main scanning direction as shown in FIG. 7A, and the case where the solid patches of the CMK colors are located at the same position in the sub scanning direction, at the same position along the main scanning direction as shown in FIG. 7B. In the case of color printing, employing the first all-color total pixel value, which is the total of the pixel value of each of CMYK colors of each of the plurality of pixels included in each of the N×M pieces of blocks (second all-color total pixel value which is the total of the first all-color total pixel value of each of the predetermined number of blocks included in each of the A×B pieces of object blocks), to determine the fixing temperature of the fixing device 13, enables the fixing temperature of the fixing device 13 to be properly controlled.

In addition, storing the first total pixel value of each of the N×M pieces of blocks (in the case of color printing, the first total pixel value of each of CMYK colors and the first all-color total pixel value, in the case of monochrome printing, the first total pixel value of K color) in the continuous addresses of the image memory 20 eliminates the need to provide additional hardware to identify the positions respectively corresponding to the N×M pieces of blocks, thereby suppressing an increase in hardware resource.

According to the foregoing embodiment, for example, when at least one of the second all-color total pixel values of the A×B pieces of object blocks exceeds the first threshold (YES at S111), the fixing temperature of the fixing device 13 is set to the first fixing temperature for color printing (step S115), and when none of the second all-color total pixel values of the A×B pieces of object blocks exceed the first threshold (NO at S111), the operation proceeds to step S112. However, the disclosure is not limited to such arrangement. For example, the following process may be adopted. After step S110, the fixing controller 123 calculates an (a−b)th average value, which is the average of the second all-color total pixel value of the object block located at the a-th position along the sub scanning direction, “a” being an integer between 1 and A, both ends inclusive, and at the b-th position along the main scanning direction, b being an integer between 1 and B−1, both ends inclusive, and the second all-color total pixel value of the object block located at the a-th position along the sub scanning direction, and at the (b+1)th position along the main scanning direction. Then the fixing controller 123 decides, instead of step s111, whether at least one of (a−b)th average values (a being an integer between 1 and A, both ends inclusive, and b being an integer between 1 and B−1, both ends inclusive) exceeds a predetermined threshold (hereinafter, “fourth threshold” where appropriate). Upon deciding that at least one of the (a−b)th average values exceeds the fourth threshold, the fixing controller 123 sets the fixing temperature of the fixing device 13 to the first fixing temperature for color printing (step S115), but proceeds to step S112, upon deciding that none of the (a−b)th average values exceed the fourth threshold.

According to the foregoing embodiment, when at least one of the second all-color total pixel values of the A×B pieces of object blocks exceeds the first threshold, the fixing temperature of the fixing device 13 is set to the first fixing temperature for color printing, and also when none of the second all-color total pixel values of the A×B pieces of object blocks exceed the first threshold, and at least one of the b-th average values exceeds the third threshold, the fixing temperature of the fixing device 13 is set to the first fixing temperature for color printing, but when none of the b-th average values exceed the third threshold, the fixing temperature of the fixing device 13 is set to the second fixing temperature for color printing, lower than the first fixing temperature for color printing. However, the disclosure is not limited to such arrangement. For example, when at least one of the second all-color total pixel values of the A×B pieces of object blocks exceeds the first threshold, the fixing temperature of the fixing device 13 may be set to the first fixing temperature for color printing. When none of the second all-color total pixel values of the A×B pieces of object blocks exceed the first threshold, and at least one of the b-th average values exceeds the third threshold, the fixing temperature of the fixing device 13 may be set to a third fixing temperature for color printing, lower than the first fixing temperature for color printing. When none of the b-th average values exceed the third threshold, the fixing temperature of the fixing device 13 may be set to a fourth fixing temperature for color printing, lower than the third fixing temperature for color printing. Further, in the case where the fixing temperatures are specified in advance, with respect to a plurality of sections defined by two or more predetermined thresholds, such that the fixing temperature becomes higher in the section defined by the higher threshold, and the fixing temperatures specified for the respective sections are equal to or lower than the first fixing temperature for color printing, the fixing controller 123 may set the fixing temperature of the fixing device 13 to a fixing temperature corresponding to the section including the largest b-th average value, when none of the second all-color total pixel values of the A×B pieces of object blocks exceed the first threshold.

According to the foregoing embodiment, when at least one of the (a-b)th average value exceeds the fourth threshold, the fixing temperature of the fixing device 13 is set to the first fixing temperature for color printing. When none of the (a−b)th average value exceed the first threshold, and at least one of the b-th average values exceeds the third threshold, the fixing temperature of the fixing device 13 is set to the first fixing temperature for color printing, and when none of the b-th average values exceed the third threshold, the fixing temperature of the fixing device 13 is set to the second fixing temperature for color printing, lower than the first fixing temperature for color printing. However, the disclosure is not limited to such arrangement. For example, when at least one of the (a−b)th average values exceeds the fourth threshold, the fixing temperature of the fixing device 13 may be set to the first fixing temperature for color printing. When none of the (a−b)th average values exceed the first threshold, and at least one of the b-th average values exceeds the third threshold, the fixing temperature of the fixing device 13 may be set to the third fixing temperature for color printing, lower than the first fixing temperature for color printing. When none of the b-th average values exceed the third threshold, the fixing temperature of the fixing device 13 may be set to the fourth fixing temperature for color printing, lower than the third fixing temperature for color printing. Further, in the case where the fixing temperatures are specified in advance, with respect to a plurality of sections defined by two or more predetermined thresholds, such that the fixing temperature becomes higher in the section defined by the higher threshold, and the fixing temperatures specified for the respective sections are equal to or lower than the first fixing temperature for color printing, the fixing controller 123 may set the fixing temperature of the fixing device 13 to a fixing temperature corresponding to the section including the largest b-th average value, when none of the (a−b)th average values exceed the first threshold.

According to the foregoing embodiment, the fixing temperature of the fixing device 13 is determined at step S111 solely on the basis of the first threshold. However, the disclosure is not limited to such embodiment. For example, a plurality of thresholds may be prepared, and the fixing temperature of the fixing device 13 may be controlled in a plurality of stages, such that the fixing temperature of the fixing device 13 becomes higher, when the largest second all-color total pixel value exceeds the higher threshold, and that the operation proceeds to step S112, when the largest second all-color total pixel value does not exceed the lowest threshold. Likewise, although the fixing temperature of the fixing device 13 is determined solely on the basis of the fourth threshold, in the variation of step S111, instead a plurality of thresholds may be prepared, and the fixing temperature of the fixing device 13 may be controlled in a plurality of stages, such that the fixing temperature of the fixing device 13 becomes higher, when the largest (a−b)th average value exceeds the higher threshold, and that the operation proceeds to step S112, when the largest (a−b)th average value does not exceed the lowest threshold.

According to the foregoing embodiment, the setting process of the fixing temperature of the fixing device 13, shown in FIG. 8 and FIG. 9 is executed by the fixing controller 123 of the engine controller 120. However, the disclosure is not limited to such embodiment. The print controller 110 may execute the setting process of the fixing temperature of the fixing device 13, shown in FIG. 8 and FIG. 9, and notify the determined fixing temperature to the fixing controller 123 of the engine controller 120, and the fixing controller 123 may control the fixing temperature of the fixing device 13, on the basis of the fixing temperature notified.

The fixing temperature of the fixing device 13 is determined, not only depending on whether color printing or monochrome printing is to be performed, but also depending on various parameters, such as the sheet weight, printing speed (speed reduction in silent mode or high-resolution printing mode), use environment of the image forming apparatus 1 (whether high temperature or low temperature), and the picture quality (e.g., printing on glossy sheet). Therefore, the fixing temperature may be determined on the basis of the combination with such parameters.

In the case of the existing technique to control the fixing temperature according to the deposited toner amount, detection units for identifying the positions respectively corresponding to a plurality of meshes are required as additional hardware, in addition to the counters that count the deposited toner amount, respectively provided for the plurality of meshes. The detection units for identifying the mesh position, of the number corresponding to the maximum amount of the mesh positions to be identified, are required. Therefore, when the page size of the image data is large, such as the case of banner printing, the number of meshes becomes enormous, which leads to a significant increase in hardware resource that has to be additionally prepared.

Here, even when the same image is to be printed, the count value of the deposited toner amount may largely vary, depending on the positional relation between the image drawing region in the page and the meshes. Accordingly, it is difficult to determine, on the basis of the count value of the deposited toner amount, the fixing temperature of the fixing device that suppresses the power consumption by the fixing device, and assures that the toner image is properly fixed onto the sheet. Further, some of the image forming apparatuses are configured to accept an input of image data formed in a plurality of resolution levels, and therefore there is a demand for a technique to determine the fixing temperature of the fixing device, so as to suppress the power consumption by the fixing device, and assure that the toner image is properly fixed onto the sheet, irrespective of the resolution level of the image data.

The arrangement according to the disclosure enables the power consumption by the fixing device to be suppressed, and assures that the toner image is properly fixed onto the sheet, irrespective of the positional relation between the image drawing region in the page and the blocks formed by dividing the image data, and of the resolution level of the image data.

The disclosure may be modified in various manners, without limitation to the configuration and processings according to the foregoing embodiment and the variations thereof. Further, the configurations and processings described in the embodiments with reference to FIG. 1 to FIG. 10 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is;

1. An image forming apparatus comprising:
an image forming device that forms a toner image on a sheet, on a basis of image data;
a fixing device that heats and presses the sheet on which the toner image has been formed;
a transport device that transports the sheet to the image forming device and the fixing device; and
a control device including a processor, and configured to act as a controller that controls a fixing temperature of the fixing device, when the processor executes a control program,
the controller being configured to:
execute a total pixel value acquisition process, including acquiring a first total pixel value which is a total of the pixel value of each of a plurality of pixels, included in each of N×M pieces of blocks, defined by dividing the image data into a predetermined size;
define A×B pieces of object blocks in the N×M pieces of blocks, by grouping a predetermined number of the blocks, according to data resolution of the image data, into one object block, and execute a total pixel value calculation process including calculating a second total pixel value, which is a total of the first total pixel value of the predetermined number of the blocks, included in each of the A×B pieces of object blocks;
arrange the A×B pieces of object blocks such that A pieces of blocks are aligned along a transport direction of the sheet by the transport device, and B pieces of blocks are aligned along an orthogonal direction orthogonal to the transport direction, and execute an average value calculation process, including calculating a b-th average value (b being an integer between 1 and B−1, both ends inclusive), which is an average of a total of the second total pixel value of each of the A pieces of object blocks, aligned in the transport direction at a position of a b-th object block in the orthogonal direction, and a total of the second total pixel value of each of the A pieces of object blocks, aligned in the transport direction at a position of a (b+1)th object block in the orthogonal direction; and
execute a fixing temperature setting process, including setting the fixing temperature of the fixing device to a predetermined first fixing temperature, when at least one of the b-th average values exceeds a predetermined threshold, and setting the fixing temperature of the fixing device to a fixing temperature, predetermined according to the b-th average value, and lower than the first fixing temperature, when none of the b-th average values exceed the predetermined threshold.

2. The image forming apparatus according to claim 1,
wherein, when the data resolution is P times as high as predetermined data resolution, the controller defines the object block by grouping P×P pieces of the blocks of the predetermined number, including P pieces aligned in the transport direction and P pieces aligned in the transport direction.

3. An image forming apparatus comprising:
an image forming device that forms a toner image on a sheet using a plurality of colors, on a basis of image data;
a fixing device that heats and presses the sheet on which the toner image has been formed;
a transport device that transports the sheet to the image forming device and the fixing device; and
a control device including a processor, and configured to act as a controller that controls a fixing temperature of the fixing device, when the processor executes a control program,
the controller being configured to:
execute a total pixel value acquisition process, including acquiring, with respect to each of the colors, a first total pixel value of a color, which is a total of the pixel value of the color, of each of a plurality of pixels, included in each of N×M pieces of blocks, defined by dividing the image data into a predetermined size;
define A×B pieces of object blocks in the N×M pieces of blocks, by grouping a predetermined number of the blocks, according to data resolution of the image data, into one object block, and execute a total pixel value calculation process including calculating, with respect to each of the colors, a second total pixel value of a color, which is a total of the first total pixel value of the color, of the predetermined number of the blocks, included in each of the A×B pieces of object blocks;
arrange the A×B pieces of object blocks such that A pieces of blocks are aligned along a transport direction of the sheet by the transport device, and B pieces of blocks are aligned along an orthogonal direction orthogonal to the transport direction, and execute an average value calculation process, including calculating a b-th average value (b being an integer between 1 and B−1, both ends inclusive), which is an average of a total of the second total pixel value of each of the plurality of colors, of each of the A pieces of object blocks, aligned in the transport direction at a position of a b-th object block in the orthogonal direction, and a total of the second total pixel value of each of the plurality of colors, of each of the A pieces of object blocks, aligned in the transport direction at a position of a (b+1)th object block in the orthogonal direction; and
execute a fixing temperature setting process, including setting the fixing temperature of the fixing device to a predetermined first fixing temperature, when at least one of the b-th average values exceeds a predetermined threshold, and setting the fixing temperature of the fixing device to a fixing temperature, predetermined according to the b-th average value, and lower than the first fixing temperature, when none of the b-th average values exceed the predetermined threshold.

4. The image forming apparatus according to claim 3,
wherein, when the data resolution is P times as high as predetermined data resolution, the controller defines the object block by grouping P×P pieces of the blocks of the predetermined number, including P pieces aligned in the transport direction and P pieces aligned in the transport direction.

5. The image forming apparatus according to claim 3,
wherein the controller is configured to:
acquire, with respect to each of the colors, the first total pixel value of the color, which is the total of the pixel value of the color, of each of the plurality of pixels, included in each of the N×M pieces of blocks, and also a first all-color total pixel value, which is the total of the pixel value of each of the plurality of colors, of each of the plurality of pixels included in each of the blocks, in the total pixel value acquisition process;
calculate, with respect to each of the colors, the second total pixel value of the color, which is the total of the first total pixel value of the color, of each of the predetermined number of blocks included in each of the A×B pieces of object blocks, and also a second all-color total pixel value which is a total of the first all-color total pixel value of each of the predetermined number of blocks included in each of the object blocks, in the total pixel value calculation process;
decide whether at least one of the second all-color total pixel values of the A×B pieces of object blocks exceeds a predetermined first threshold;
set the fixing temperature of the fixing device to the first fixing temperature, upon deciding that at least one of the second all-color total pixel values of the A×B pieces of object blocks exceeds the first threshold; and
execute the average value calculation process and the fixing temperature setting process, upon deciding that none of the second all-color total pixel values of the A×B pieces of object blocks exceed the first threshold.
